(19) United States
(12) Patent Application Publication
(10) Pub. No.: US 2021/0199891 A1
(43) Pub. Date: Jul. 1, 2021

(54) OPTICAL DEVICE AND LASER APPARATUS

(71) Applicant: FUJIKURA LTD., Tokyo (JP)

(72) Inventor: Ryokichi Matsumoto, Chiba (JP)

(73) Assignee: FUJIKURA LTD., Tokyo (JP)

(21) Appl. No.: 17/269,839

(22) PCT Filed: Sep. 19, 2019
(86) PCT No.: PCT/JP2019/036667

§ 371 Date: Feb. 19, 2021

(30) Foreign Application Priority Data
Oct. 12, 2018 (JP) 2018-193746

(51) Int. Cl. G02B 6/28; G02B 6/42; G02B 6/26; H01S 3/067

(52) U.S. Cl. CPC G02B 6/2804; H01S 3/06745; G02B 6/262; G02B 6/42

(57) ABSTRACT

An optical device includes: first optical fibers, a second optical fiber, a fiber connection portion, a fiber support portion; and a fixation resin that fixes the first optical fibers to the fiber support portion. The first optical fibers form a tapered portion including a taper initiation portion and a taper body reduced in diameter toward the fiber connection portion. The core of the second optical fiber has a core exposure area exposed outside of the first optical fibers. At least a portion of a periphery of the fixation resin is disposed closer to an optical axis of the second optical fiber than to a first reference line that is an extension of a line that passes through a closest point of the taper initiation portion to the optical axis on a plane perpendicular to the optical axis.

### TECHNICAL FIELD

The present invention relates to an optical device and a laser apparatus using the same, and more particularly to an optical device having a fiber connection portion where optical fibers are connected to each other.

### BACKGROUND

In the field of laser processing that uses a fiber laser or the like, improvement of the processing speed and capability of processing thick materials is expected when the power of laser light is increased. Therefore, there has been required to increase the power of laser light in recent years. In order to increase the power of laser light, beams of output light from a plurality of laser light sources may be combined, or beams of pumping light from a plurality of pumping light sources are introduced into a laser cavity. At that time, a plurality of optical fibers and one optical fiber may be connected to each other by an optical combiner (see, e.g., Patent Literature 1).

FIG. 1 is a perspective view schematically showing such a conventional optical combiner. In the optical combiner shown in FIG. 1, beams of light propagating through cores 910 of multiple input optical fibers 901 are combined and introduced into a core 920 of an output optical fiber 902. At that time, the shape of an end face of the cores 910 of the input optical fibers 901 does not perfectly match the shape of an end face of the core 920 of the output optical fiber 902. In order to prevent light propagating from the input optical fiber 901 to the output optical fiber 902 from leaking out at the connection portion, the optical combiner is generally designed such that an area for all of the cores 910 of the input optical fibers 901 is inside of the core 920 of the output optical fiber 902.

As the power of laser light is increased as described above, however, laser light reflected from a workpiece during laser processing or pumping light emitted from a backward pumping light source in a bidirectional pumping fiber laser may propagate from the output optical fiber 902 into the input optical fibers 901. In such a case, the reflection light or the pumping light is irradiated into an external space from an exposed area of the core 920 in the output optical fiber 902, as indicated by the arrows of FIG. 1. The reflection light or the pumping light thus irradiated into the external space is applied to a resin that fixes the input optical fibers 901, thereby causing degradation of the resin and hence a failure of the optical combiner.

### PATENT LITERATURE

Patent Literature 1: JP 2017-191298 A

### SUMMARY

One or more embodiments of the present invention relate to an optical device capable of inhibiting degradation of a resin that fixes an optical fiber.

One or more embodiments of the present invention also relate to a laser apparatus that is unlikely to cause a failure.

According to one of more embodiments of the present invention, there is provided an optical device capable of inhibiting degradation of a resin that fixes an optical fiber. The optical device has at least one first optical fiber, a second optical fiber, a fiber connection portion where a core of the first optical fiber and a core of the second optical fiber are connected to each other, a fiber support portion configured to support the first optical fiber and the second optical fiber, and a fixation resin that fixes the first optical fiber to the fiber support portion. The first optical fiber has a tapered portion including a taper initiation portion and a taper body reduced in diameter from the taper initiation portion toward the fiber connection portion. The core of the second optical fiber has a core exposure area exposed outside of the first optical fiber at the fiber connection portion. At least a portion of a periphery of the fixation resin is located closer to an optical axis of the second optical fiber than a first reference line that is an extension of a line passing through the closest point of the taper initiation portion to the optical axis on a plane perpendicular to the optical axis, among other lines drawn from a point of an inside contour defining the core exposure area to any point of the taper initiation portion on the plane perpendicular to the optical axis without intersecting the taper body. As used herein, “the optical axis of the second optical fiber” refers to an axis formed by extending an optical axis within the second optical fiber to the point at infinity. A distance from any point to the optical axis is defined by a length of a perpendicular line from the point to the optical axis. The magnitude of the distance determines whether the point is away from the optical axis or close to the optical axis.

According to one of more embodiments of the present invention, there is provided a laser apparatus that is unlikely to cause a failure. The laser apparatus has at least one laser light source and the aforementioned optical device. The first optical fiber of the optical device is connected to the at least one laser light source.

### BRIEF DESCRIPTION OF DRAWINGS

FIG. 1 is a perspective view schematically showing a conventional optical combiner.

FIG. 2 is a diagram schematically showing a laser apparatus according to a first embodiment of the present invention.

FIG. 3 is a diagram schematically showing a primary portion of the optical combiner according to the first embodiment of the present invention.

FIG. 4 is a perspective view schematically showing the vicinity of a fiber connection portion of the optical combiner illustrated in FIG. 3.

FIG. 5 is a schematic view showing an arrangement of input optical fibers on a taper initiation portion of a tapered portion illustrated in FIG. 4.

FIG. 6 is a schematic view showing the positional relationship between cores of the input optical fibers and a core of an output optical fiber on the fiber connection portion of the optical combiner illustrated in FIG. 3.

FIG. 7 is a schematic diagram showing a core exposure area in the output optical fiber illustrated in FIG. 3.

FIG. 8 is a schematic diagram showing an outer circumferential contour of the taper initiation portion of the tapered portion illustrated in FIG. 5.

FIG. 9A is a schematic diagram explanatory of a propagation path of an optical feedback in the optical combiner illustrated in FIG. 3.

FIG. 9B is a schematic diagram explanatory of a propagation path of an optical feedback in the optical combiner illustrated in FIG. 3.

FIG. 9C is a schematic diagram explanatory of a propagation path of an optical feedback in the optical combiner illustrated in FIG. 3.

FIG. 9D is a schematic diagram explanatory of a propagation path of an optical feedback in the optical combiner illustrated in FIG. 3.

FIG. 10 is a diagram schematically showing a primary portion of an optical combiner according to a second embodiment of the present invention.

FIG. 11 is a diagram schematically showing a primary portion of an optical combiner according to a third embodiment of the present invention.

FIG. 12 is a diagram schematically showing a primary portion of an optical combiner according to a fourth embodiment of the present invention.

FIG. 13 is a diagram schematically showing a primary portion of an optical combiner according to a fifth embodiment of the present invention.

FIG. 14 is a diagram schematically showing a primary portion of an optical combiner according to a sixth embodiment of the present invention.

FIG. 15 is a diagram schematically showing a primary portion of an optical combiner according to a seventh embodiment of the present invention.

FIG. 16 is a diagram schematically showing a primary portion of an optical combiner according to an eighth embodiment of the present invention.

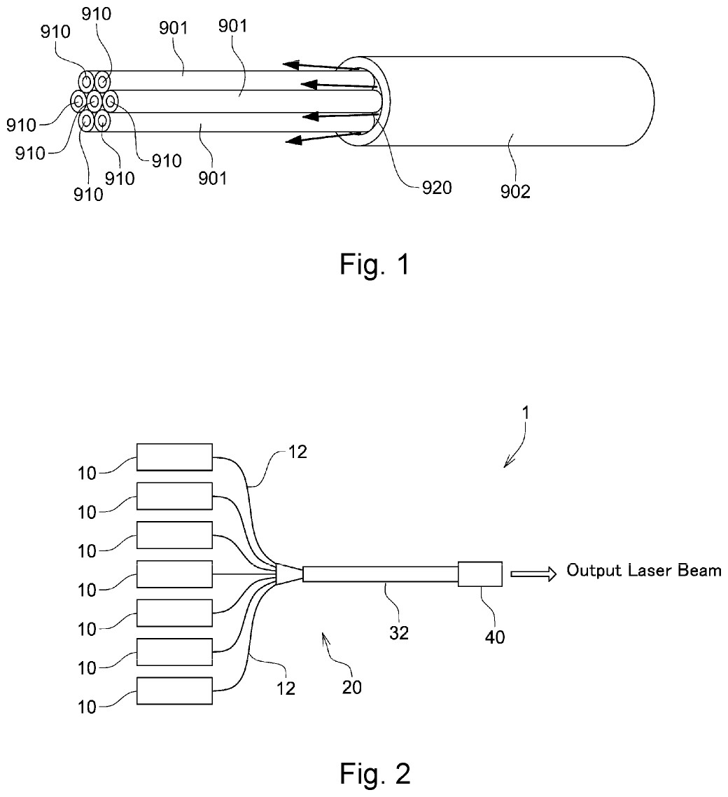

### DETAILED DESCRIPTION

Embodiments of an optical device and a laser apparatus using such an optical device according to the present invention will be described in detail below with reference to FIGS. 2 to 16. In the following description, an optical combiner is illustrated as an example of an optical device according to the present invention. However, an optical device according to the present invention is not limited to the illustrated example. In FIGS. 2 to 16, the same or corresponding components are denoted by the same or corresponding reference numerals and will not be described below repetitively. Furthermore, in FIGS. 2 to 16, the scales or dimensions of components may be exaggerated, or some components may be omitted.

FIG. 2 is a diagram schematically showing a laser apparatus 1 according to a first embodiment of the present invention. As shown in FIG. 2, the laser apparatus 1 includes a plurality of fiber lasers 10 as laser light sources, an optical combiner 20 configured to combine laser beams outputted from the fiber lasers 10, and an emission end 40 that emits the combined output laser beam to, for example, a workpiece. The optical combiner 20 includes a plurality of input optical fibers 12 (first optical fibers) extending from the fiber laser 10 and an output optical fiber 32 (second optical fiber) connected to the input optical fibers 12. Laser beams emitted from a plurality of fiber lasers 10 propagate through the respective input optical fibers 12. The laser beams are introduced and combined into one output optical fiber 32 and then emitted from the emission end 40.

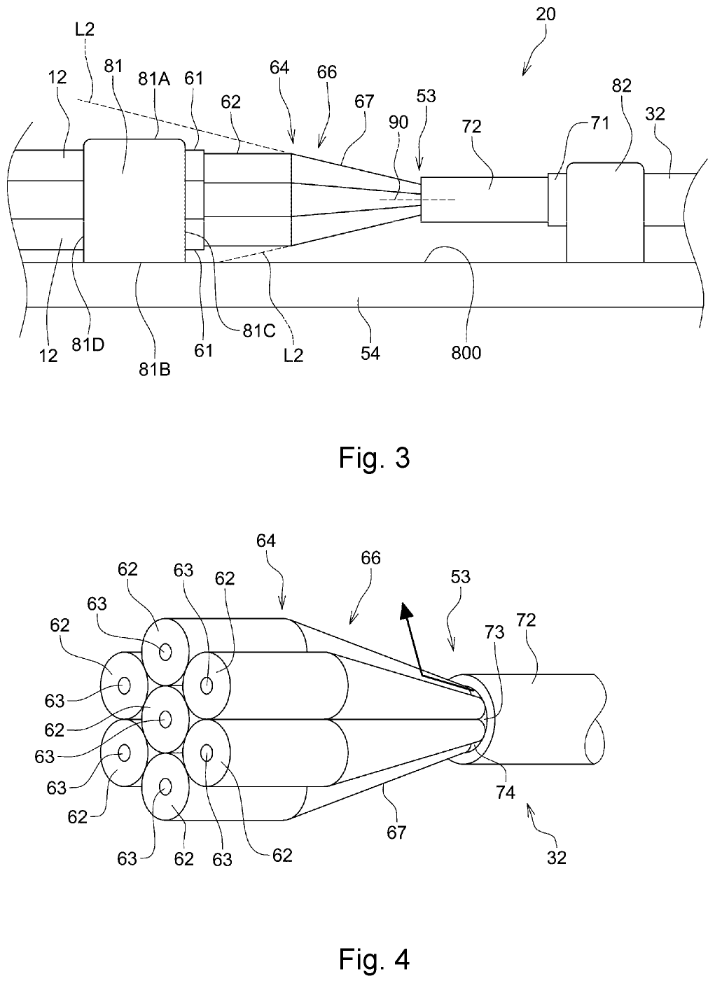

FIG. 3 is a diagram schematically showing a primary portion of the optical combiner 20. As shown in FIG. 3, the optical combiner 20 has a fiber connection portion 53 where a bundle of the multiple input optical fibers 12 and the output optical fiber 32 are connected to each other. Furthermore, the optical combiner 20 includes a fiber support portion 54 in the form of a plate for supporting the input optical fibers 12 and the output optical fiber 32. The input optical fibers 12 and the output optical fiber 32 are fixed to the fiber support portion 54 by fixation resins 81 and 82, respectively.

A covering material 61 has been removed from an end of each of the input optical fibers 12 near the fiber connection portion 53 so as to expose an outer cladding 62. A tapered portion 66 is formed on a portion of the exposed outer claddings 62 of the input optical fibers 12 at the fiber connection portion 53. The tapered portion 66 includes a taper initiation portion 64 and a taper body 67 reduced in diameter gradually from the taper initiation portion 64 toward the fiber connection portion 53. Furthermore, a covering material 71 has been removed from an end of the output optical fiber 32 near the fiber connection portion 53 so as to expose an outer cladding 72. The exposed end of the outer cladding 72 of the output optical fiber 32 and the tapered portion 66 of the input optical fibers 12 are connected to each other at the fiber connection portion 53.

FIG. 4 is a perspective view schematically showing the vicinity of the fiber connection portion 53 of the optical combiner 20. Laser beams emitted from a plurality of fiber lasers 10 propagate in the respective cores 63 of the input optical fibers 12. The laser beams are introduced into the core 73 of the output optical fiber 32 through the tapered portion 66. Thus, laser beams emitted from a plurality of fiber lasers 10 are introduced into one core 73 of the output optical fiber 32 so as to form a high-power laser beam. Therefore, a high-power laser beam is emitted from the emission end 40 after it propagates through the core 73 of the output optical fiber 32.

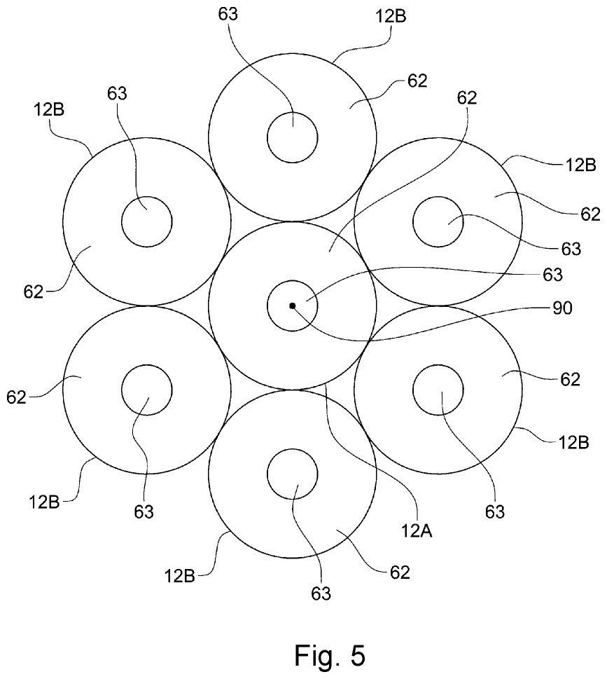

FIG. 5 is a schematic view showing an arrangement of the input optical fibers 12 on the taper initiation portion 64. As shown in FIG. 5, in the present embodiment, seven optical fibers are used as the input optical fibers 12. Six optical fibers 12B are arranged around one optical fiber 12A such that the optical fibers 12B and the optical fiber 12A are held in contact with each other.

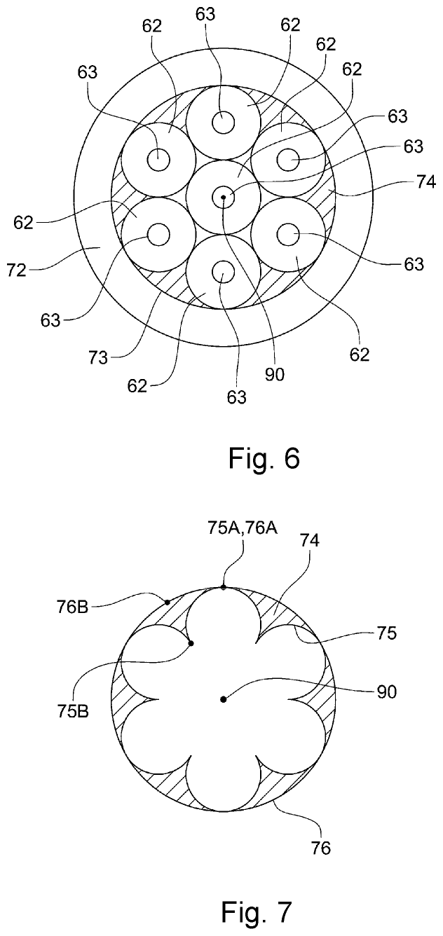

FIG. 6 is a schematic view showing the positional relationship between the cores 63 of the input optical fibers 12 and the core 73 of the output optical fiber 32 on the fiber connection portion 53 of the optical combiner 20. As shown in FIGS. 4 and 6, in order to prevent light propagating from the input optical fibers 12 to the output optical fiber 32 from leaking out at the fiber connection portion 53, the optical combiner 20 is designed such that an area for all of the cores 63 of the input optical fibers 12 is inside of the core 73 of the output optical fiber 32. The shape of the core 73 of the output optical fiber 32 does not perfectly match the shape of an end of the tapered portion 66 (the taper body 67) of the input optical fibers 12. Accordingly, a portion of an area of the core 73 in the output optical fiber 32 is exposed outside of the input optical fibers 12 at the fiber connection portion 53. Specifically, the core 73 of the output optical fiber 32 has a core exposure area 74 (a hatched area in FIG. 6), which is exposed outside of the input optical fibers 12 on the fiber connection portion 53.

For example, when a high-power laser beam is directed from the emission end 40 to the workpiece, the laser beam reflected from the workpiece may return to the laser apparatus 1 at the emission end 40 and propagate toward the input optical fibers 12. Such an optical feedback is irradiated into an external space from the aforementioned core exposure area 74. The optical combiner 20 of the present embodiment has a structure in which such an optical feedback is not applied to the fixation resin 81. Specifically, as indicated by the arrow of FIG. 4, an optical feedback irradiated to the external space from the core exposure area 74 is reflected on an outer circumferential surface of the taper body 67 in the tapered portion 66 of the input optical fibers 12, so that it does not reach the fixation resin 81. This feature will be described below.

The aforementioned optical feedback is irradiated at various angles from the core exposure area 74. When the optical feedback is incident on the outer circumferential surface of the taper body 67, the optical feedback is reflected from the outer circumferential surface of the taper body 67 as indicated by the arrow of FIG. 4 because it has a large angle of incidence and there is a large difference between the refractive index of glass, which forms the tapered portion 66, and the refractive index of air. Accordingly, a shadow portion where no optical feedback is directly applied is produced on an upstream side of the tapered portion 66. When the fixation resin 81 is placed in the shadow portion, no optical feedback is applied directly to the fixation resin 81, so that degradation of the fixation resin 81 can be inhibited. Thus, the optical combiner 20 becomes unlikely to cause a failure.

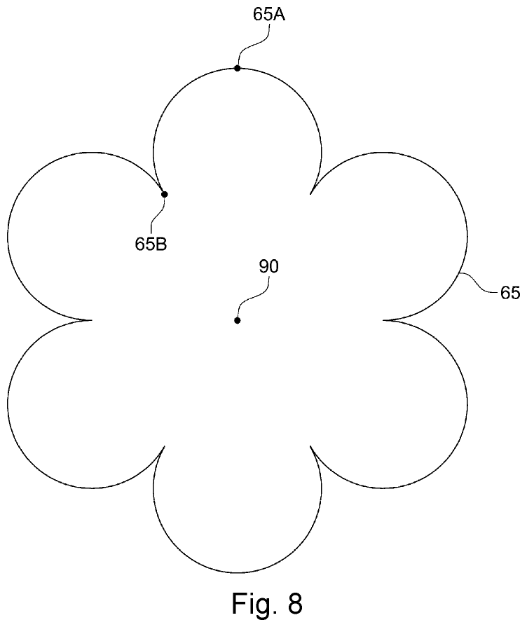

FIG. 7 is a schematic diagram showing the core exposure area 74 in the output optical fiber 32, and FIG. 8 is a schematic diagram showing a line (outer circumferential contour) 65 defining an outer circumferential surface of the taper initiation portion 64 of the tapered portion 66. As shown in FIG. 7, the core exposure area 74 is an area defined by an inside contour 75, which includes six circular arcs arranged in a circumferential direction about an optical axis 90 of the output optical fiber 32 and connected to each other, and an outside contour 76, which includes a single circle. Furthermore, as shown in FIG. 8, the outer circumferential contour 65 has a shape formed by six circular arcs arranged in a circumferential direction about the optical axis 90 and connected to each other.

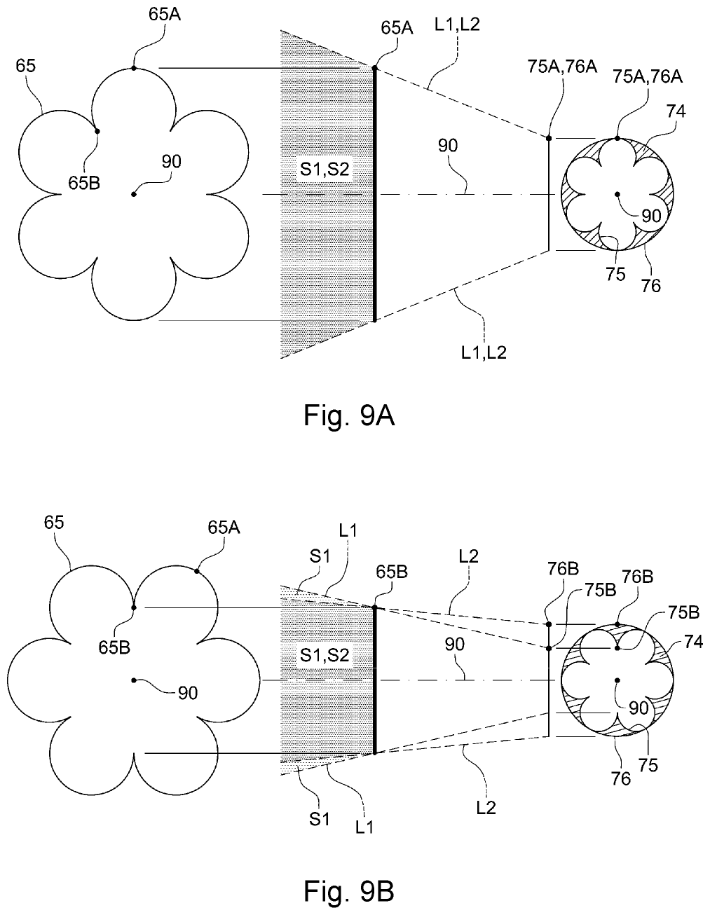

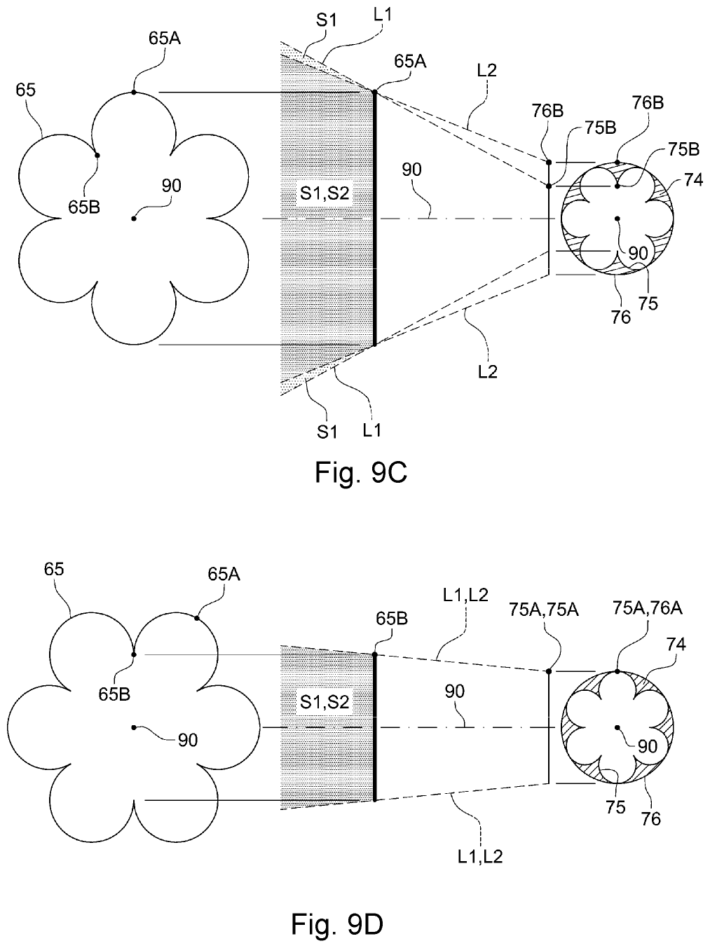

The amount of the optical feedback decreases on an upstream side of the tapered portion 66 in a region that is closer to the optical axis 90 than a reference line, which is an extension of a line passing through the closest point to the optical axis 90 of the output optical fiber 32 on the outer circumferential contour 65 of the taper initiation portion 64, among other lines drawn from a point on the inside contour 75 of the core exposure area 74 to a point on the outer circumferential contour 65 of the taper initiation portion 64 without intersecting the taper body 67. For example, as shown in FIG. 9A, an optical feedback irradiated from a point 75A on the inside contour 75 of the core exposure area 74 (see also FIG. 7) does not reach a region S1, which is closer to the optical axis 90 than a reference line L1 (first reference line) passing through the point 75A on the inside contour 75 and a point 65A on the outer circumferential contour 65 of the taper initiation portion 64. Accordingly, the amount of the optical feedback introduced into the region S1 decreases. Furthermore, as shown in FIG. 9B, an optical feedback irradiated from a point 75B on the inside contour 75 of the core exposure area 74 (see also FIG. 7) does not reach a region S1, which is closer to the optical axis 90 than a reference line L1 (first reference line) passing through the point 75B on the inside contour 75 and a point 65B on the outer circumferential contour 65 of the taper initiation portion 64. Accordingly, the amount of the optical feedback introduced into the region Si decreases. Thus, when the fixation resin 81 is placed in the region S1, the amount of the optical feedback applied to the fixation resin 81 decreases so that degradation of the fixation resin 81 due to the optical feedback can be inhibited.

Furthermore, a shadow region formed by the optical feedback on an upstream side of the tapered portion 66 is a region that is closer to the optical axis 90 than a reference line, which is an extension of a line passing through the closest point to the optical axis 90 of the output optical fiber 32 on the outer circumferential contour 65 of the taper initiation portion 64, among other lines drawn from a point on the outside contour 76 of the core exposure area 74 to a point on the outer circumferential contour 65 of the taper initiation portion 64 without intersecting the taper body 67. For example, as shown in FIG. 9A, an optical feedback irradiated from a point 76A on the outside contour 76 of the core exposure area 74 (coincident with the point 75A; see also FIG. 7) does not reach a region S2, which is closer to the optical axis 90 than a reference line L2 (second reference line) passing through the point 76A on the outside contour 76 and the point 65A on the outer circumferential contour 65 of the taper initiation portion 64. Accordingly, the region S2 is in a complete shadow formed by the optical feedback. Thus, no optical feedback is applied directly to the region S2. Furthermore, as shown in FIG. 9B, an optical feedback irradiated from a point 76B on the outside contour 76 of the core exposure area 74 (see also FIG. 7) does not reach a region S2, which is closer to the optical axis 90 than a reference line L2 (second reference line) passing through the point 76B on the outside contour 76 and the point 65B on the outer circumferential contour 65 of the taper initiation portion 64. Accordingly, the region S2 is in a complete shadow formed by the optical feedback. Thus, no optical feedback is applied directly to the region S2. Therefore, when the fixation resin 81 is placed in the region S2, no optical feedback is applied directly to the fixation resin 81 so that degradation of the fixation resin 81 can be inhibited.

Furthermore, the tapered portion 66 may have a tapered shape twisted midway. In such a case, the core exposure area 74 shifts in the circumferential direction with respect to the outer circumferential contour 65. For example, if the core exposure area 74 shifts in the circumferential direction with respect to the outer circumferential contour 65 by 30 degrees, as shown in FIG. 9C, an optical feedback irradiated from the point 75B on the inside contour 75 of the core exposure area 74 does not reach a region S1, which is closer to the optical axis 90 than a reference line L1 (first reference line) passing through the point 75B on the inside contour 75 and the point 65A on the outer circumferential contour 65 of the taper initiation portion 64. Accordingly, the amount of the optical feedback introduced into the region S1 decreases. Furthermore, as shown in FIG. 9D, an optical feedback irradiated from the point 75A on the inside contour 75 of the core exposure area 74 does not reach a region S1, which is closer to the optical axis 90 than a reference line L1 (first reference line) passing through the point 75A of the inside contour 75 and the point 65B on the outer circumferential contour 65 of the taper initiation portion 64. Therefore, the amount of the optical feedback introduced into the region S1 decreases. Thus, when the fixation resin 81 is placed in the region S1, the amount of the optical feedback applied to the fixation resin 81 decreases so that degradation of the fixation resin 81 due to the optical feedback can be inhibited.

Furthermore, as shown in FIG. 9C, an optical feedback irradiated from the point 76B on the outside contour 76 of the core exposure area 74 does not reach a region S2, which is closer to the optical axis 90 than a reference line L2 (second reference line) passing through the point 76B on the outside contour 76 and the point 65A on the outer circumferential contour 65 of the taper initiation portion 64. Accordingly, the region S2 is in a complete shadow formed by the optical feedback. Thus, no optical feedback is applied directly to the region S2. Furthermore, as shown in FIG. 9D, an optical feedback irradiated from the point 76A on the outside contour 76 of the core exposure area 74 does not reach a region S2, which is closer to the optical axis 90 than a reference line L2 (second reference line) passing through the point 76A on the outside contour 76 and the point 65B on the outer circumferential contour 65 of the taper initiation portion 64. Accordingly, the region S2 is in a complete shadow formed by the optical feedback. Thus, no optical feedback is applied directly to the region S2. Therefore, when the fixation resin 81 is placed in the region S2, no optical feedback is applied directly to the fixation resin 81 so that degradation of the fixation resin 81 can be inhibited.

In the present embodiment, as shown in FIG. 3, an upper peripheral portion 81A, a lower peripheral portion 81B, and side peripheral portions 81C and 81D of the fixation resin 81 are located closer to the optical axis 90 of the output optical fiber 32 than the reference line L2. Therefore, the entire fixation resin 81 is located within the region S2, which is in a shadow formed by the optical feedback. Thus, no optical feedback is applied directly to the fixation resin 81. Accordingly, degradation of the fixation resin 81 due to the optical feedback is inhibited, so that the optical combiner 20 becomes unlikely to cause a failure. Even if the fixation resin 81 is located in the region S1 where a shadow may be produced by the optical feedback, influence from the optical feedback can be reduced as described above.

In the above example, the first reference line is defined as an extension of a line passing through the closest point to the optical axis 90 of the output optical fiber 32 on the outer circumferential contour 65 of the taper initiation portion 64, among other lines drawn from a point on the inside contour 75 of the core exposure area 74 to a point on the outer circumferential contour 65 of the taper initiation portion 64 without intersecting the taper body 67. In practice, the tapered portion 66 may have a shape swelled midway. In such a case, a line drawn from a point on the inside contour 75 of the core exposure area 74 to a point on the outer circumferential contour 65 of the initiation portion 64 may intersect the taper body 67. In this case, when the first reference line is defined as an extension of a line passing through the closest point of the taper initiation portion 64 to the optical axis 90 on a plane perpendicular to the optical axis 90, among other lines drawn from a point on the inside contour 75 of the core exposure area 74 to any point of the taper initiation portion 64 on the plane perpendicular to the optical axis 90 without intersecting the taper body 67, then a region that is closer to the optical axis 90 than the first reference line will be a shadow portion formed by the optical feedback. Therefore, when the fixation resin 81 is placed closer to the optical axis 90 than the first reference line, no optical feedback is applied directly to the fixation resin 81 so that degradation of the fixation resin 81 can be inhibited. This also holds true for the following embodiments.

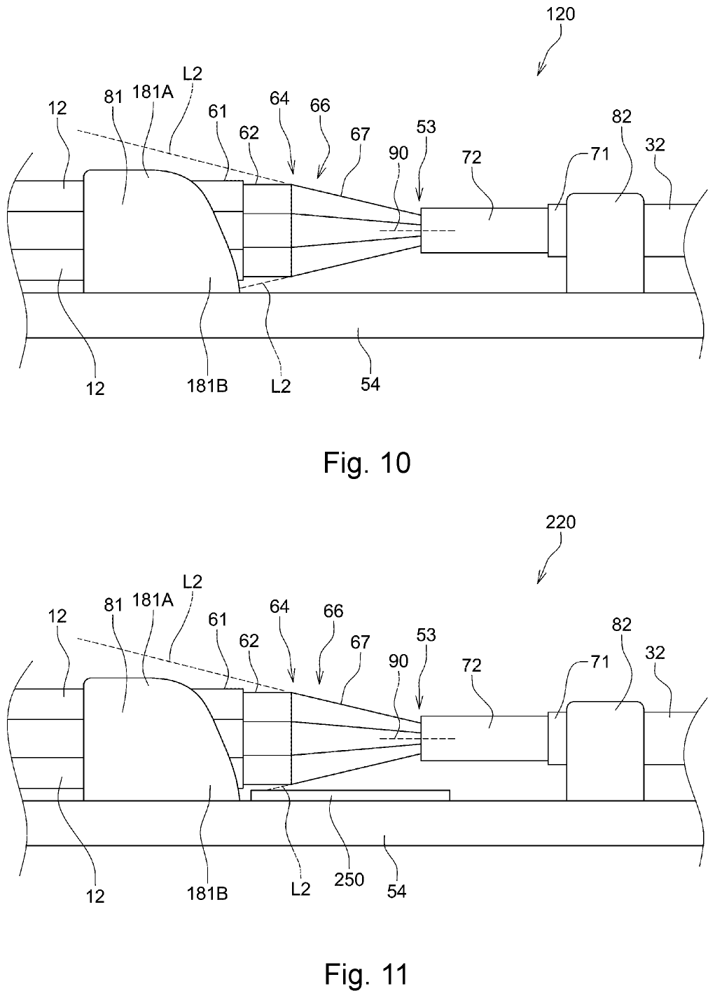

FIG. 10 is a diagram schematically showing a primary portion of an optical combiner 120 according to a second embodiment of the present invention. In the aforementioned first embodiment, all peripheral portions of the fixation resin 81 are located closer to the optical axis 90 of the output optical fiber 32 than the reference line L2. Nevertheless, if any part of the peripheral portion of the fixation resin 81 is located closer to the optical axis 90 of the output optical fiber 32 than the reference line L2 (or the reference line L1), then the aforementioned effects can be demonstrated with respect to that part. In the present embodiment, the fixation resin 81 spreads from an upper end portion 181A toward a lower end portion 181B. Thus, a portion of the lower end portion 181B of the fixation resin 81 located on an outer side of the reference line L2 (away from the optical axis 90).

In the example illustrated in FIG. 10, since an optical feedback is applied to a part of the lower end portion 181B of the fixation resin 81 that is located on the outer side of the reference line L2, the temperature of the applied part of the lower end portion 181B may increase. However, the lower end portion 181B of the fixation resin 81 is held in contact with the fiber support portion 54, which may also serve as a radiator plate. Therefore, even if heat is generated at the lower end portion 181B of the fixation resin 81, the generated heat is likely to be dissipated through the fiber support portion 54. Thus, influence from the optical feedback can be reduced. Meanwhile, the upper end portion 181A of the fixation resin 81 is in contact with air, which has a low thermal conductivity. Therefore, in order to suppress heat generation, the upper end portion 181A of the fixation resin 81 is arranged in the shadow region formed by the optical feedback, i.e., closer to the optical axis 90 than the reference line L2 (or the reference line L1).

Furthermore, in the present embodiment, since the fixation resin 81 spreads from the upper end portion 181A toward the lower end portion 181B, the lower end portion 181B of the fixation resin 81 can be arranged closer to the tapered portion 66. In other words, the input optical fibers 12 can be fixed to the fiber support portion 54 at a location closer to the tapered portion 66. Therefore, a distance between a location at which the input optical fibers 12 are fixed to the fiber support portion 54 and a location at which the output optical fiber 32 is fixed to the fiber support portion 54 can be shortened such that the input optical fibers 12 and the output optical fiber 32 can firmly be fixed to the fiber support portion 54. As a result, the length of the optical combiner 120 can be reduced while the mechanical reliability of the optical combiner 120 can be enhanced.

In the present embodiment, as described above, an optical feedback irradiated from the core exposure area 74 of the output optical fiber 32 to the external space is applied to a portion of the fixation resin 81. An opaque resin for the fixation resin 81 is used in order to prevent the optical feedback applied to the fixation resin 81 from propagating within the fixation resin 81.

FIG. 11 is a diagram schematically showing a primary portion of an optical combiner 220 according to a third embodiment of the present invention. In the second embodiment, the optical feedback is applied to the lower end portion 181B of the fixation resin 81. In this regard, the fiber support portion 54 of the present embodiment has a light shield portion 250 configured to shield an optical feedback from being applied to the lower end portion 181B of the fixation resin 81. The light shield portion 250 may have any shape as long as it has a portion extending to a side closer to the optical axis 90 over the reference line L2 (or the reference line L1) between the lower end portion 181B of the fixation resin 81 and the taper initiation portion 64 of the tapered portion 66.

Even if the lower end portion 181B of the fixation resin 81 is located on an outer side of the reference line L2 (or the reference line L1), the optical feedback is shielded by the light shield portion 250 before it is applied to the lower end portion 181B of the fixation resin 81. Accordingly, the optical feedback can be inhibited from being applied to the fixation resin 81.

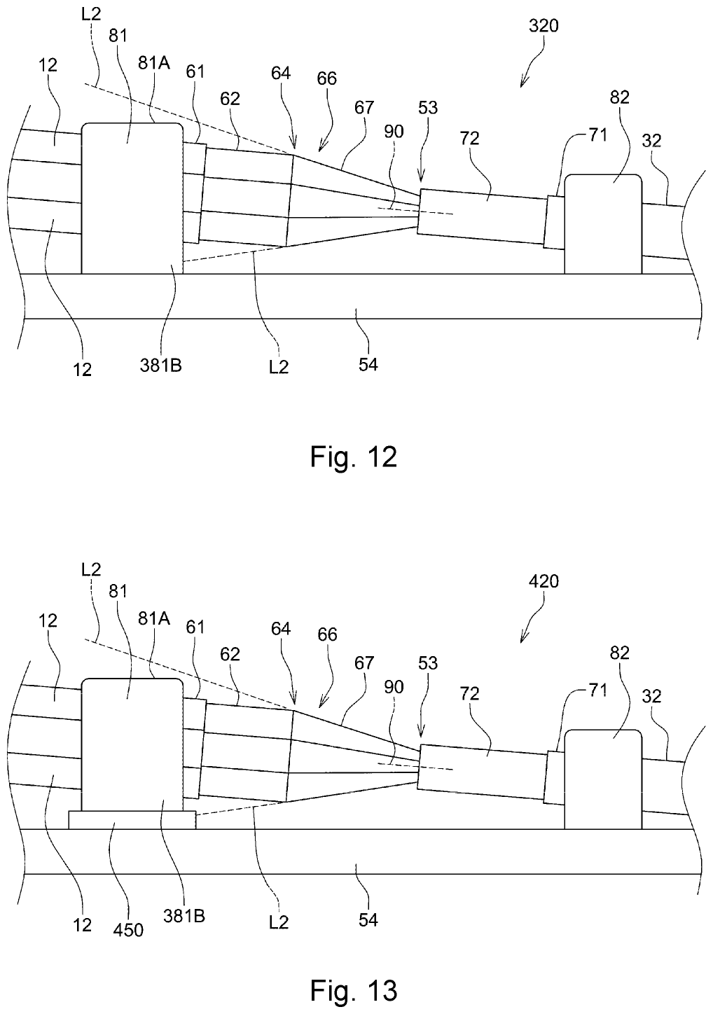

FIG. 12 is a diagram schematically showing a primary portion of an optical combiner 320 according to a fourth embodiment of the present invention. In the aforementioned first embodiment, the input optical fibers 12 and the output optical fiber 32 extend in parallel to a direction in which the fiber support portion 54 extends. In the present embodiment, the input optical fibers 12 and the output optical fiber 32 are arranged so as to be oblique with respect to a direction in which the fiber support portion 54 extends. In other words, the input optical fibers 12 and the output optical fiber 32 are inclined with respect to the fiber support portion 54 such that the distance between the input optical fibers 12 and the fiber support portion 54 increases as the distance from the fiber connection portion 53 increases in the input optical fibers 12. The input optical fibers 12 and the output optical fiber 32 are inclined with respect to the fiber support portion 54 such that the distance between the output optical fiber 32 and the fiber support portion 54 decreases as the distance from the fiber connection portion 53 increases in the output optical fiber 32. The fixation resins 81 and 82 fix the input optical fibers 12 and the output optical fiber 32 in such an inclined state, respectively, to the fiber support portion 54.

Such inclination of the input optical fibers 12 facilitates arrangement of the upper peripheral portion 81A of the fixation resin 81, which is in contact with air having a low thermal conductivity, in the region S2 (or the region S1) closer to the optical axis 90 than the reference line L2 (or the reference line L1). In this case, as shown in FIG. 12, a part of the lower end portion 381B of the fixation resin 81 is likely to be located on an outer side of the reference line L2 (away from the optical axis 90). However, the lower end portion 381B of the fixation resin 81 is held in contact with the fiber support portion 54, which may also serve as a radiator plate as described above. Therefore, even if the optical feedback is applied to the lower end portion 381B of the fixation resin 81 to generate heat, the generated heat is likely to be dissipated through the fiber support portion 54. Thus, influence from the optical feedback can be reduced.

FIG. 13 is a diagram schematically showing a primary portion of an optical combiner 420 according to a fifth embodiment of the present invention. The present embodiment corresponds to an example where a light shield portion 450 extending to a side closer to the optical axis 90 over the reference line L2 (or the reference line L1) is provided near a lower end portion 381B of the fixation resin 81 to which the optical feedback would be applied in the aforementioned fourth embodiment. Such a light shield portion 450 inhibits the optical feedback from being applied to the lower end portion 381B of the fixation resin 81, so that degradation of the fixation resin 81 due to the optical feedback can be inhibited.

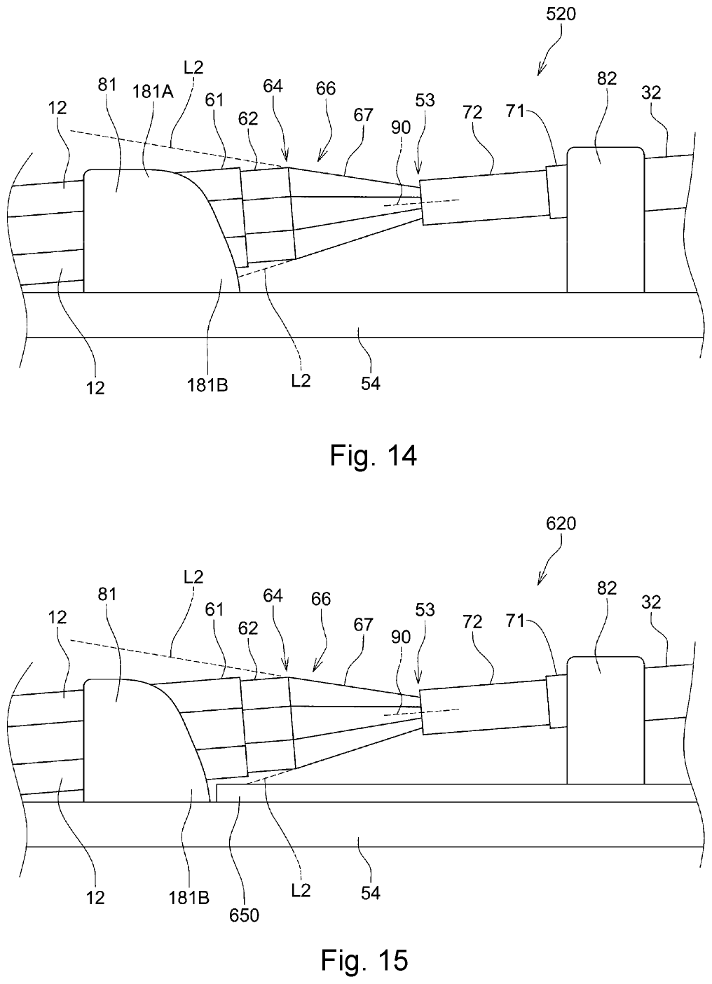

FIG. 14 is a diagram schematically showing a primary portion of an optical combiner 520 according to a sixth embodiment of the present invention. The present embodiment is inverse to the aforementioned fourth embodiment. The input optical fibers 12 and the output optical fiber 32 are inclined with respect to the fiber support portion 54 such that the distance between the input optical fibers 12 and the fiber support portion 54 decreases as the distance from the fiber connection portion 53 increases in the input optical fibers 12. The input optical fibers 12 and the output optical fiber 32 are inclined with respect to the fiber support portion 54 such that the distance between the output optical fiber 32 and the fiber support portion 54 increases as the distance from the fiber connection portion 53 increases in the output optical fiber 32. The fixation resins 81 and 82 fix the input optical fibers 12 and the output optical fiber 32 in such an inclined state, respectively, to the fiber support portion 54.

Such inclination of the input optical fibers 12 allows the input optical fibers 12 to be fixed to the fiber support portion 54 at a location closer to the tapered portion 66. Accordingly, a distance between a location at which the input optical fibers 12 are fixed to the fiber support portion 54 and a location at which the output optical fiber 32 is fixed to the fiber support portion 54 can be shortened such that the input optical fibers 12 and the output optical fiber 32 can firmly be fixed to the fiber support portion 54. As a result, the length of the optical combiner 520 can be reduced while the mechanical reliability of the optical combiner 520 can be enhanced.

In the example illustrated in FIG. 14, a part of the lower end portion 181B of the fixation resin 81 is located on an outer side of the reference line L2 (or the reference line L1) (away from the optical axis 90). However, the lower end portion 181B of the fixation resin 81 is held in contact with the fiber support portion 54, which may also serve as a radiator plate. Therefore, even if heat is generated in the lower end portion 181B of the fixation resin 81, the generated heat is likely to be dissipated through the fiber support portion 54. Thus, influence from the optical feedback can be reduced.

FIG. 15 is a diagram schematically showing a primary portion of an optical combiner 620 according to a seventh embodiment of the present invention. The present embodiment corresponds to an example where the light shield portion 650 extending to a side closer to the optical axis 90 over the reference line L2 (or the reference line L1) is provided near the lower end portion 181B of the fixation resin 81 to which the optical feedback would be applied in the aforementioned sixth embodiment. Such a light shield portion 650 inhibits the optical feedback from being applied directly to the lower end portion 181B of the fixation resin 81, so that degradation of the fixation resin 81 due to the optical feedback can be inhibited.

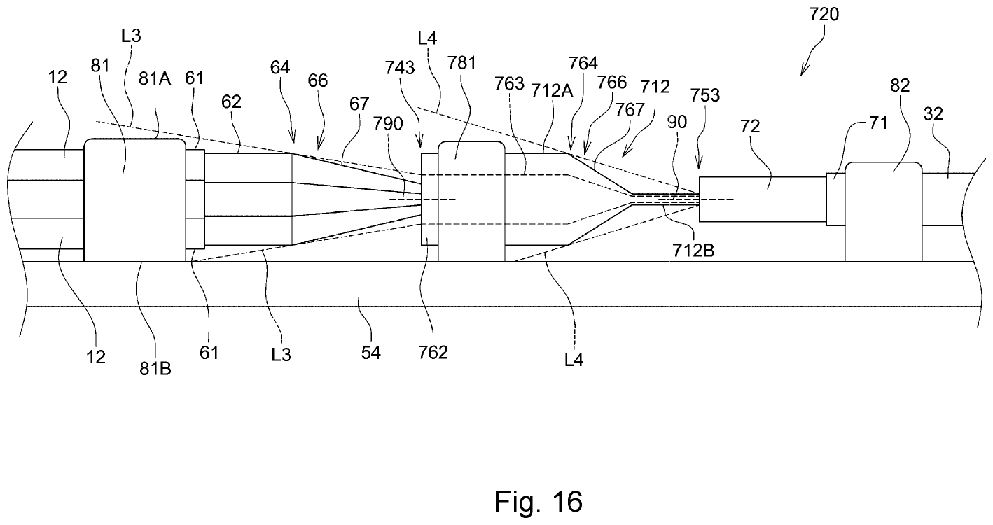

FIG. 16 is a diagram schematically showing a primary portion of an optical combiner 720 according to an eighth embodiment of the present invention. According to the present embodiment, a bridge fiber 712 is connected between the input optical fibers 12 and the output optical fiber 32 of the first embodiment. The bridge fiber 712 has a single core 763 and an outer cladding 762 surrounding an outer circumference of the core 763. A larger-diameter portion 712A having a large diameter is formed near the input optical fibers 12, while a smaller-diameter portion 712B having a small diameter is formed near the output optical fiber 32.

The end of the tapered portion 66 of the input optical fibers 12 and the larger-diameter portion 712A of the bridge fiber 712 are connected to each other at a first fiber connection portion 743. The smaller-diameter portion 712B of the bridge fiber 712 and the end of the output optical fiber 32 are connected at a second fiber connection portion 753. A tapered portion 766 is formed between the larger-diameter portion 712A and the smaller-diameter portion 712B of the bridge fiber 712. The tapered portion 766 includes a taper initiation portion 764 and a taper body 767 reduced in diameter gradually from the taper initiation portion 764 toward the second fiber connection portion 753. The bridge fiber 712 is fixed to the fiber support portion 54 by the fixation resin 781.

With this configuration, laser beams emitted from a plurality of fiber lasers 10 propagate in the respective cores 63 of the input optical fibers 12. The laser beams are introduced into the core 763 of the bridge fiber 712 through the tapered portion 66. While the laser beams introduced into the core 763 of the bridge fiber 712 propagate through the core 763 with reduced diameters, they are introduced into the core 73 of the output optical fiber 32. Thus, laser beams emitted from a plurality of fiber lasers 10 are introduced into one core 73 of the output optical fiber 32 so as to form a high-power laser beam. Therefore, a high-power laser beam is emitted from the emission end 40 after it propagates through the core 73 of the output optical fiber 32. When a plurality of tapered portions 66 and 766 are provided in this manner, the ratio of diameter reduction in one tapered portion can be reduced, which facilitates fusion splice between optical fibers.

Since the shape of the core 763 of the bridge fiber 712 does not match the shape of the end of the tapered portion 66 of the input optical fibers 12, a portion of an area of the core 763 in the bridge fiber 712 is exposed outside of the input optical fibers 12 at the first fiber connection portion 743. Thus, a core exposure area is formed. In the present embodiment, the fixation resin 81 is placed in a region that is closer to the optical axis 790 than a reference line L3, which is an extension of a line passing through the closest point to the optical axis 790 of the bridge fiber 712 on the outer circumferential contour of the taper initiation portion 64, among other lines drawn from a point on the outside contour of the core exposure area to a point on the outer circumferential contour of the taper initiation portion 64 without intersecting the taper body 67. This region is a shadow portion formed by the optical feedback propagating from the bridge fiber 712 toward the input optical fibers 12. Therefore, no optical feedback is applied directly to the fixation resin 81 so that degradation of the fixation resin 81 can be reduced.

The fixation resin 81 may be placed in a region that is closer to the optical axis 790 than an extension of a line passing through the closest point to the optical axis 790 of the bridge fiber 712 on the outer circumferential contour of the taper initiation portion 64, among other lines drawn from a point on the inside contour of the core exposure area to a point on the outer circumferential contour of the taper initiation portion 64 without intersecting the taper body 67. Since the amount of the optical feedback introduced into this region decreases, degradation of the fixation resin 81 due to the optical feedback can be inhibited when the fixation resin 81 is placed in this region.

Ideally, the core 763 of the bridge fiber 712 and the core 73 of the output optical fiber 32 have the same diameter. In practice, the core 763 of the bridge fiber 712 and the core 73 of the output optical fiber 32 have somewhat different diameters. Therefore, a portion of an area of the core 73 in the output optical fiber 32 is also exposed outside of the bridge fiber 712 at the second fiber connection portion 753 so as to form a core exposure area. In the present embodiment, the fixation resin 781 is placed in a region that is closer to the optical axis 90 than a reference line L4, which is an extension of a line passing through the closest point to the optical axis 90 of the output optical fiber 32 on the outer circumferential contour of the taper initiation portion 764, among other lines drawn from a point on the outside contour of the core exposure area to a point on the outer circumferential contour of the taper initiation portion 764 without intersecting the taper body 767. This region is a shadow portion formed by the optical feedback propagating from the output optical fiber 32 toward the bridge fiber 712. Therefore, no optical feedback is applied directly to the fixation resin 781 so that degradation of the fixation resin 781 can be inhibited.

The fixation resin 781 may be placed in a region that is closer to the optical axis 90 than an extension of a line passing through the closest point to the optical axis 90 of the output optical fiber 32 on the outer circumferential contour of the taper initiation portion 764, among other lines drawn from a point on the inside contour of the core exposure area to a point on the outer circumferential contour of the taper initiation portion 764 without intersecting the taper body 767. Since the amount of the optical feedback introduced into this region decreases, degradation of the fixation resin 781 due to the optical feedback can be inhibited when the fixation resin 781 is placed in this region.

While the tapered portion 66 of the input optical fibers 12 is formed of seven optical fibers, the tapered portion 766 of the bridge fiber 712 is formed of one optical fiber. Thus, any number of optical fibers may be used to form a tapered portion as long as at least one optical fiber is used for the tapered portion. Nevertheless, the reference line L2 in FIGS. 9A to 9D requires three or more input optical fibers 12.

In the aforementioned first to eighth embodiments, a reflection inhibition portion for inhibiting reflection of light emitted from the aforementioned core exposure area may be provided in a region that is farther away from the optical axis 90 or 790 than the reference line L1-L4. For example, a surface of the fiber support portion 54 may be subjected to black alumite processing to absorb light emitted from the core exposure area, thereby forming a reflection inhibition portion 800 (see FIG. 3). Alternatively, a white light scattering surface may be formed as a reflection inhibition portion in the surface of the fiber support portion 54 to scatter light emitted from the core exposure area. Alternatively, a reflection inhibition portion formed of a transparent body may be provided so as to allow light emitted from the core exposure area to pass through the transparent body for inhibiting mirror reflection.

The aforementioned embodiments describe examples in which light reflected from a workpiece returns as an optical feedback to the output optical fiber 32 toward the input optical fibers 12. However, the light propagating from the output optical fiber 32 toward the input optical fibers 12 is not limited to such an optical feedback. For example, pumping light emitted from a backward pumping light source in a bidirectional pumping fiber laser may also be the light propagating from the output optical fiber 32 toward the input optical fibers 12.

Although one or more embodiments of the present invention have been described, the present invention is not limited to the aforementioned embodiments. It should be understood that various different forms may be applied to the present invention within the technical idea thereof.

As described above, according to one or more embodiments the present invention, there is provided an optical device capable of inhibiting degradation of a resin that fixes an optical fiber. The optical device has at least one first optical fiber, a second optical fiber, a fiber connection portion where a core of the first optical fiber and a core of the second optical fiber are connected to each other, a fiber support portion configured to support the first optical fiber and the second optical fiber, and a fixation resin that fixes the first optical fiber to the fiber support portion. The first optical fiber has a tapered portion including a taper initiation portion and a taper body reduced in diameter from the taper initiation portion toward the fiber connection portion. The core of the second optical fiber has a core exposure area exposed outside of the first optical fiber at the fiber connection portion. At least a portion of a periphery of the fixation resin is located closer to an optical axis of the second optical fiber than a first reference line that is an extension of a line passing through the closest point of the taper initiation portion to the optical axis on a plane perpendicular to the optical axis, among other lines drawn from a point of an inside contour defining the core exposure area to any point of the taper initiation portion on the plane perpendicular to the optical axis without intersecting the taper body.

With this configuration, light propagating from the second optical fiber toward the first optical fiber is irradiated from the core exposure area of the fiber connection portion to an external space. The amount of light being introduced decreases on a side closer to the optical axis than the first reference line. Therefore, when at least a portion of the periphery of the fixation resin is located closer to the optical axis than the first reference line, the fixation resin is inhibited from being degraded by irradiation of light propagating from the second optical fiber toward the first optical fiber. Accordingly, the optical combiner becomes unlikely to cause a failure, resulting in enhanced reliability of the optical combiner.

The first reference line may be a line passing through the closest point to the optical axis on an outer circumferential contour of the taper initiation portion, among other lines drawn from a point on the inside contour to a point on the outer circumferential contour of the taper initiation portion without intersecting the taper body.

The at least one first optical fiber may include three or more first optical fibers. In this case, at least a portion of the periphery of the fixation resin may be located closer to the optical axis than a second reference line that is an extension of a line passing through the closest point to the optical axis on the outer circumferential contour of the taper initiation portion, among other lines drawn from a point on an outside contour defining the core exposure area to a point on the outer circumferential contour of the taper initiation portion without intersecting the taper body. The region that is closer to the optical axis than the second reference line is a shadow portion formed by the light propagating from the second optical fiber toward the first optical fiber. Therefore, when at least a portion of the periphery of the fixation resin is located closer to the optical axis than the second reference line, light propagating from the second optical fiber toward the first optical fiber is not applied to the fixation resin. Accordingly, degradation of the fixation resin is inhibited, so that the optical combiner becomes unlikely to cause a failure.

A portion of the fixation resin that contacts the fiber support portion may spread more widely than a portion of the fixation resin that is located away from the fiber support portion. In this case, the fixation resin can be arranged closer to the tapered portion. Thus, the first optical fiber can be fixed to the fiber support portion at a location closer to the tapered portion. Therefore, a distance between a location at which the first optical fiber is fixed to the fiber support portion and a location at which the second optical fiber is fixed to the fiber support portion can be shortened such that the first optical fiber and the second optical fiber can firmly be fixed to the fiber support portion. As a result, the length of the optical combiner can be reduced while the mechanical reliability of the optical combiner can be enhanced.

The fiber support portion may have a reflection inhibition portion arranged farther away from the optical axis than the first reference line. The reflection inhibition portion is provided for inhibiting reflection of light emitted from the core exposure area.

A portion of the periphery of the fixation resin may be located farther away from the optical axis than the first reference line. In this case, the fiber support portion may have a light shield portion extending to a side closer to the optical axis over the first reference line between the portion of the periphery of the fixation resin and the taper initiation portion of the tapered portion. Even if the portion of the periphery of the fixation resin is located on a side farther away from the optical axis than the first reference line, light propagating from the second optical fiber toward the first optical fiber is shielded by the light shield portion before it is applied to the fixation resin. Accordingly, the light can be inhibited from being applied to the fixation resin.

The fixation resin may fix the first optical fiber to the fiber support portion in a state in which the first optical fiber is inclined with respect to a direction in which the fiber support portion extends such that a distance between the first optical fiber and the fiber support portion increases as a distance from the fiber connection portion increases.

The fixation resin may fix the first optical fiber to the fiber support portion in a state in which the first optical fiber is inclined with respect to a direction in which the fiber support portion extends such that a distance between the first optical fiber and the fiber support portion decreases as a distance from the fiber connection portion increases.

The whole periphery of the fixation resin may be located closer to the optical axis than the first reference line.

According to one or more embodiments of the present invention, there is provided a laser apparatus that is unlikely to cause a failure. The laser apparatus has at least one laser light source and the aforementioned optical device. The first optical fiber of the optical device is connected to the at least one laser light source. With this laser apparatus, degradation of the fixation resin of the optical combiner can be inhibited as described above, and the optical combiner becomes unlikely to cause a failure. Accordingly, the laser apparatus also becomes unlikely to cause a failure.

According to one or more embodiments of the present invention, a fixation resin is inhibited from being degraded by irradiation of light propagating from a second optical fiber toward a first optical fiber. Thus, an optical combiner becomes unlikely to cause a failure.

This application claims the benefit of priority from Japanese patent application No. 2018-193746, filed on Oct. 12, 2018, the disclosure of which is incorporated herein in its entirety by reference.

The present invention is suitably used for an optical device having a fiber connection portion where optical fibers are connected to each other.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims

### DESCRIPTION OF REFERENCE NUMERALS AND SIGNS

1 Laser apparatus

10 Fiber laser

12 Input optical fiber

20 Optical combiner

32 Output optical fiber

40 Emission end

53 Fiber connection portion

54 Fiber support portion

61 Covering material

62 Outer cladding

63 Core

64 Taper initiation portion

65 Outer circumferential contour

66 Tapered portion

67 Taper body

71 Covering material

72 Outer cladding

73 Core

74 Core exposure area

75 Inside contour

76 Outside contour

81, 82 Fixation resin

90 Optical axis

120, 220, 320, 420, 520, 620, 720 Optical combiner

250, 450, 650 Light shield portion

712 Bridge fiber

712A Larger-diameter portion

712B Smaller-diameter portion

743 First fiber connection portion

753 Second fiber connection portion

762 Outer cladding

763 Core

764 Taper initiation portion

766 Tapered portion

767 Taper body

781 Fixation resin

790 Optical axis

800 Reflection inhibition portion

L1 (First) reference line

L2 (Second) reference line

L3, L4 (Second) reference line

1. An optical device comprising:
first optical fibers;
a second optical fiber;
a fiber connection portion where a core of each of the first optical fibers connects to a core of the second optical fiber;
a fiber support portion that supports the first optical fibers and the second optical fiber; and
a fixation resin that fixes the first optical fibers to the fiber support portion, wherein
the first optical fibers form a tapered portion at the fiber connection portion, wherein the tapered portion comprises:
a taper initiation portion; and
a taper body having a diameter that decreases in a direction from the taper initiation portion toward the fiber connection portion,
the core of the second optical fiber has a core exposure area exposed outside of the first optical fibers at the fiber connection portion,
at least a portion of a periphery of the fixation resin is disposed closer to an optical axis of the second optical fiber than to a first reference line that is an extension of a line that:
passes through a closest point of the taper initiation portion to the optical axis on a plane perpendicular to the optical axis, and
is drawn from a point on an inside contour defining the core exposure area to a point of the taper initiation portion on the plane perpendicular to the optical axis without intersecting the taper body.

2. The optical device as recited in claim 1, wherein
the first reference line is a line that:
passes through a closest point of the taper initiation portion to the optical axis on an outer circumferential contour of the taper initiation portion, and among other lines
is drawn from a point on the inside contour to a point on the outer circumferential contour of the taper initiation portion without intersecting the taper body.

3. The optical device as recited in claim 1, wherein
at least a portion of the periphery of the fixation resin is disposed closer to the optical axis than a second reference line that is an extension of a line that:
passes through a closest point of the taper initiation portion to the optical axis on the outer circumferential contour of the taper initiation portion, and
is drawn from a point on an outside contour defining the core exposure area to a point on the outer circumferential contour of the taper initiation portion without intersecting the taper body.

4. The optical device as recited in claim 1, wherein
a portion of the fixation resin that contacts the fiber support portion is wider than a portion of the fixation resin disposed away from the fiber support portion.

5. The optical device as recited in claim 1, wherein
the fiber support portion has a reflection inhibition portion disposed farther away from the optical axis than the first reference line, and
the reflection inhibition portion inhibiting reflection of light emitted from the core exposure area.

6. The optical device as recited in claim 1, wherein
a portion of the periphery of the fixation resin is disposed farther away from the optical axis than the first reference line, and
the fiber support portion has a light shield portion extending to a side closer to the optical axis and crossing over the first reference line between the portion of the periphery of the fixation resin and the taper initiation portion.

7. The optical device as recited in claim 1, wherein
the fixation resin fixes the first optical fibers to the fiber support portion in a state in which the first optical fibers are inclined with respect to a direction in which the fiber support portion extends, and
a distance between the first optical fibers and the fiber support portion increases as a distance from the fiber connection portion increases.

8. The optical device as recited in claim 1, wherein
the fixation resin fixes the first optical fibers to the fiber support portion in a state in which the first optical fibers are inclined with respect to a direction in which the fiber support portion extends, and
a distance between the first optical fibers and the fiber support portion decreases as a distance from the fiber connection portion increases.

9. The optical device as recited in claim 1, wherein whole of the periphery of the fixation resin is disposed closer to the optical axis than the first reference line.

10. A laser apparatus comprising:
a laser light source; and
the optical device as recited in claim 1,
wherein the first optical fibers of the optical device connect to the laser light source.

11. The optical device as recited in claim 2, wherein
at least a portion of the periphery of the fixation resin is disposed closer to the optical axis than a second reference line that is drawn from a point on an outside contour defining the core exposure area to a point on the outer circumferential contour of the taper initiation portion without intersecting the taper body, and
the second reference line is an extension of a line that passes through a closest point to the optical axis on the outer circumferential contour of the taper initiation portion.

12. The optical device as recited in claim 2, wherein a portion of the fixation resin that contacts the fiber support portion is wider than a portion of the fixation resin disposed away from the fiber support portion.

13. The optical device as recited in claim 2, wherein the fiber support portion has a reflection inhibition portion disposed farther away from the optical axis than the first reference line, the reflection inhibition portion inhibiting reflection of light emitted from the core exposure area.

14. The optical device as recited in claim 2, wherein
a portion of the periphery of the fixation resin is disposed farther away from the optical axis than the first reference line, and
the fiber support portion has a light shield portion extending to a side closer to the optical axis and crossing over the first reference line between the portion of the periphery of the fixation resin and the taper initiation portion.

15. The optical device as recited in claim 2, wherein
the fixation resin fixes the first optical fibers to the fiber support portion in a state in which the first optical fibers are inclined with respect to a direction in which the fiber support portion extends, and
a distance between the first optical fibers and the fiber support portion increases as a distance from the fiber connection portion increases.

16. The optical device as recited in claim 2, wherein
the fixation resin fixes the first optical fibers to the fiber support portion in a state in which the first optical fibers are inclined with respect to a direction in which the fiber support portion extends, and
a distance between the first optical fibers and the fiber support portion decreases as a distance from the fiber connection portion increases.

17. The optical device as recited in claim 2, wherein whole of the periphery of the fixation resin is disposed closer to the optical axis than the first reference line.
